(19) United States
(12) Patent Application Publication
(10) Pub. No.: US 2017/0031322 A1
(43) Pub. Date: Feb. 2, 2017

(54) CONTROL SYSTEM, TIMING DEVICE, AND PROCESS EXECUTED BY THE SYSTEM

(71) Applicants: FUJITSU LIMITED, Kawasaki-shi (JP); Fujitsu Electronics Inc., Yokohama-shi (JP)

(72) Inventors: Masuhito Tanaka, Meguro (JP); Ryutaro Motora, Nakano (JP); Kiyoshi Ryokai, Tama (JP); Junichi Yura, Kawasaki (JP); Daiji Itou, Itabashi (JP); Yoshio Shiibashi, Yokohama (JP)

(21) Appl. No.: 15/195,169

(22) Filed: Jun. 28, 2016

(30) Foreign Application Priority Data
Jul. 31, 2015 (JP) 2015-151562

(51) Int. Cl. G04F 1/06

(52) U.S. Cl. CPC G04F 1/066

(57) ABSTRACT

A control system includes a timing device to indicate an elapsed time from a time point at inversion of the timing device, and a computer including a transmitter to start transmission of a control signal according to a control scenario determined with a predetermined signal to a predetermined device other than the timing device if switching of the timing device to an operational mode is determined, and to transmit a signal indicating the end of the control for the predetermined device if switching of the timing device to a nonoperational mode is determined. The control system reduces the number of steps of managing tokens, archives, and token passwords by a terminal manager, and further improves the security level of the terminal.

### CROSS-REFERENCE TO RELATED APPLICATION

This application is based upon and claims the benefit of priority of the prior Japanese Patent application No. 2015-151562, filed on Jul. 31, 2015, the entire contents of which are incorporated herein by reference.

### FIELD

The embodiments discussed herein are directed to a control system, a timing device, and a process executed by the system.

### BACKGROUND

A traditional time displaying device, such as an hourglass, indicates the elapsed time by the amount of a medium passing through an opening of the device (see, for example, PTL 1).

### CITATION LIST

### Patent Literature

[Patent Literature 1] Japanese National Publication of International Patent Application No. 2003-528327

Unfortunately, such a traditional time display device merely indicates the elapsed time and cannot control peripheral components in response to the elapsed time.

### SUMMARY

In order to achieve the aforementioned object, the control system comprises a timing device comprising:

a detector to detect inversion of the timing device, and a radiotransmitter to transmit a predetermined wireless signal including identification information of the timing device or information for determining a predetermined time from a time point at the inversion of the timing device, upon detection of the inversion by the detector, the timing device indicating an elapsed time from the time point at the inversion; and

a computer comprising:

a receiver to receive the predetermined signal, and a transmitter to start transmission or a control signal according to a control scenario determined with the predetermined signal to at least one predetermined device other than the timing device if switching of the timing device to an operational mode is determined with the predetermined signal received by the receiver, and to transmit a signal indicating the end of the control for the at least one predetermined device if switching of the timing device to a nonoperational mode is determined with the predetermined signal received by the receiver.

### ADVANTAGEOUS EFFECTS OF INVENTION

According to this aspect, devices of the control system can be controlled in response to the elapsed time. The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates a schematic configuration of an environment controlling system according to a first embodiment;

FIG. 2 is an external perspective view of a timing device in the environment controlling system according to the first embodiment;

FIG. 3 is a side view of the timing device in the environment controlling system according to the first embodiment;

FIG. 4 is a block diagram illustrating the hardware configuration in the timing device in the environment controlling system according to the first embodiment;

FIG. 5 is a block diagram illustrating a functional configuration of the timing device in the environment controlling system according to the first embodiment;

FIG. 6 is a schematic diagram illustrating a hardware configuration of a management server in the environment controlling system according to the first embodiment;

FIG. 7 is a flowchart illustrating a process executed by the timing device in the environment controlling system according to the first embodiment;

FIG. 8 is a flow chart illustrating a process in the management server of the environment controlling system according to the first embodiment; and

FIG. 9 illustrates a schematic configuration of an environment controlling system according to a second embodiment.

### DESCRIPTION OF EMBODIMENT(S)

Embodiments of a timing device and a process executed by the timing device will now be described with reference to the accompanying drawings. The embodiments described below are mere illustrative examples and do not intend to exclude application of various modifications or techniques that are not described in the embodiments. The embodiments may thus be modified in various manners without departing from the gist. Furthermore, the embodiments may include other functions than the components illustrated in the drawings.

### (1) First Embodiment

### (1-1) Configuration

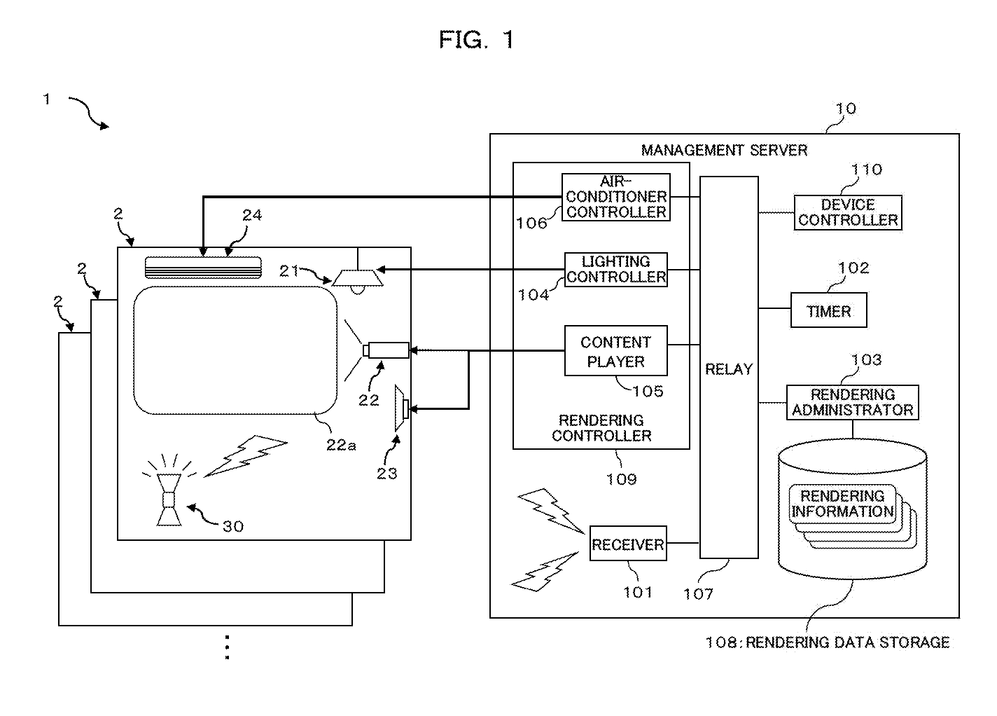

FIG. 1 illustrates a schematic configuration of an environment controlling system 1 according to a first embodiment.

The environment controlling system 1 controls the devices disposed in a target space in order that the environment of the target space is determined to be a predetermined state.

With reference to FIG. 1, the environment controlling system 1 includes at least one timing device 30 and a management server 10.

### (1-1-1) Room

FIG. 1 illustrates several rooms 2 as exemplary target spaces subjected to environment control. The environment controlling system 1 controls the environments in these rooms (facilities) 2. Each room 2 is provided with a single timing device 30.

Each room 2 is shared by several users, and each user uses the room 2 for an assigned period of time.

The rooms 2 controlled by the environment controlling system 1 illustrated in FIG. 1 have the same configuration. Each room 2 is provided with a lighting device 21, a projector 22, a screen 22a, an audio device 23, and an air conditioner 24.

The lighting device 21, the projector 22, the audio device 23, and the air conditioner 24 are in wireless or physical communication with the management server 10 described below.

The management server 10 controls the operations of the lighting device 21, the projector 22, the audio device 23, and the air conditioner 24. In other words, the lighting device 21, the projector 22, the audio device 23, and the air conditioner 24 are target (predetermined) devices controlled by the environment controlling system 1.

The lighting device 21 emits light toward the interior of the room 2. The lighting device 21 has a dimming function to produce a predetermined brightness and a toning function to yield a predetermined hue. The dimming and toning of the lighting device 21 are controlled by a lighting controller 104 in the management server 10 described below. The dimming and toning functions of the lighting device 21 can be achieved by a known technique on which description is omitted.

The projector 22 projects images to be displayed. In the environment controlling system 1, the projector 22 projects images on a screen 22a disposed on the wall of the room 2, for example.

The images projected from the projector 22 include moving images and static images. The term “images” used hereinafter refers to both moving images and static images.

For example, the projector 22 projects the images in response to a projection instruction transmitted together with images from a content player 105 in the management server 10.

The projector 22 may be connected to a computer or an image player to project images produced by the computer or the image player. The management server 10 may control the computer or the image player connected to the projector 22 to cause the projector 22 to project images.

The audio device 23 outputs sounds. In the environment controlling system 1, the audio device 23 generates to output musical sounds and sound effects (hereinafter also referred to as “music”) through a speaker or speakers (not shown) disposed on the wall of the room 2, for example. For example, the audio device 23 outputs the musical sounds and the sound effects in response to a play instruction transmitted together with musical sounds and sound effects from the content player 105 in the management server 10. The audio device 23 may be connected to a computer or a music player to output musical sounds or sound effects produced by the computer or the music player. The management server 10 may control the computer or the music player connected to the audio device 23 to cause the audio device 23 to output the musical sounds or the sound effects.

The air conditioner 24 controls the temperature and humidity in the room 2. The air conditioner 24 controls and maintains the room 2 at a predetermined temperature and a predetermined humidity in accordance with the air-conditioner controller 106 in the management server 10. The room 2 may be provided with an operation panel with which a predetermined temperature and a predetermined humidity can be input. The air conditioner 24 may control to maintain the room 2 at the predetermined temperature and humidity in response to the input operation with the operational panel.

The lighting device 21, the projector 22, the audio device 23, and the air conditioner 24 each have device identification information (a device identifier), and are controlled by a device controller 110 in the management server 10 described below.

Each room 2 is provided with a timing device 30.

### (1-1-2) Timing Device

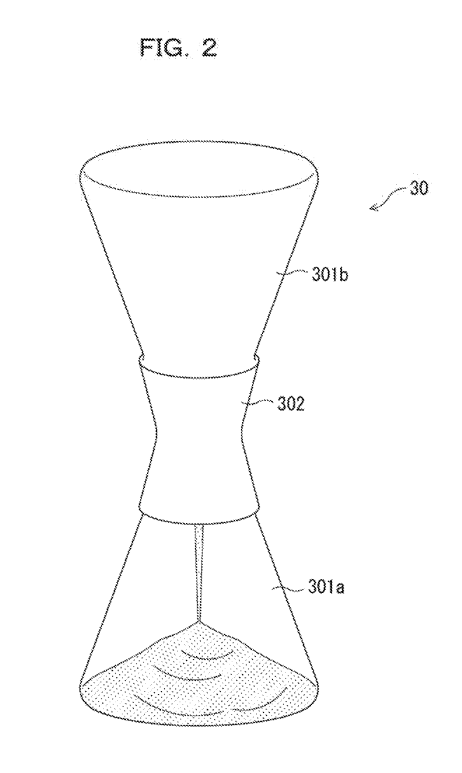

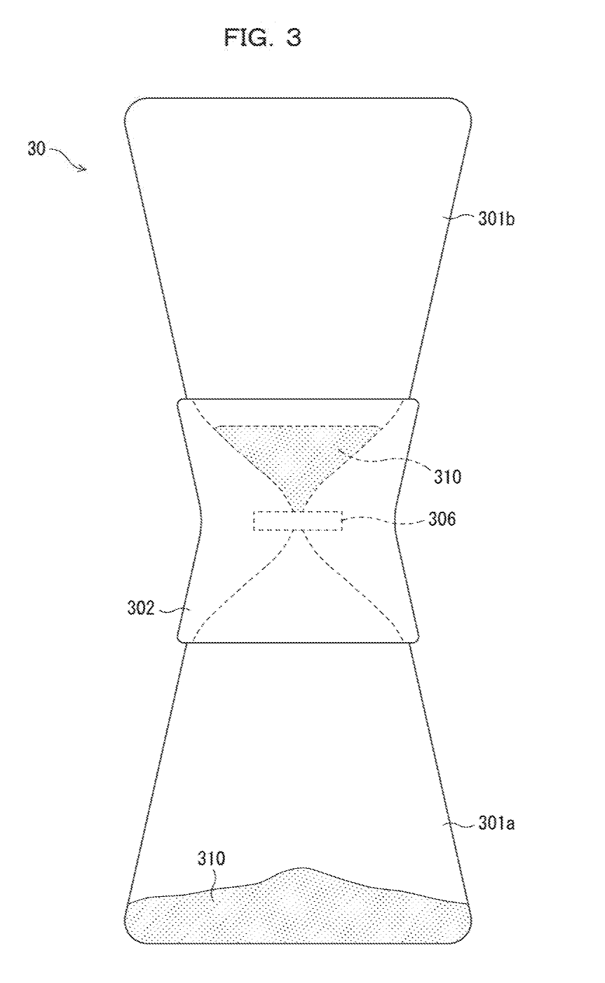

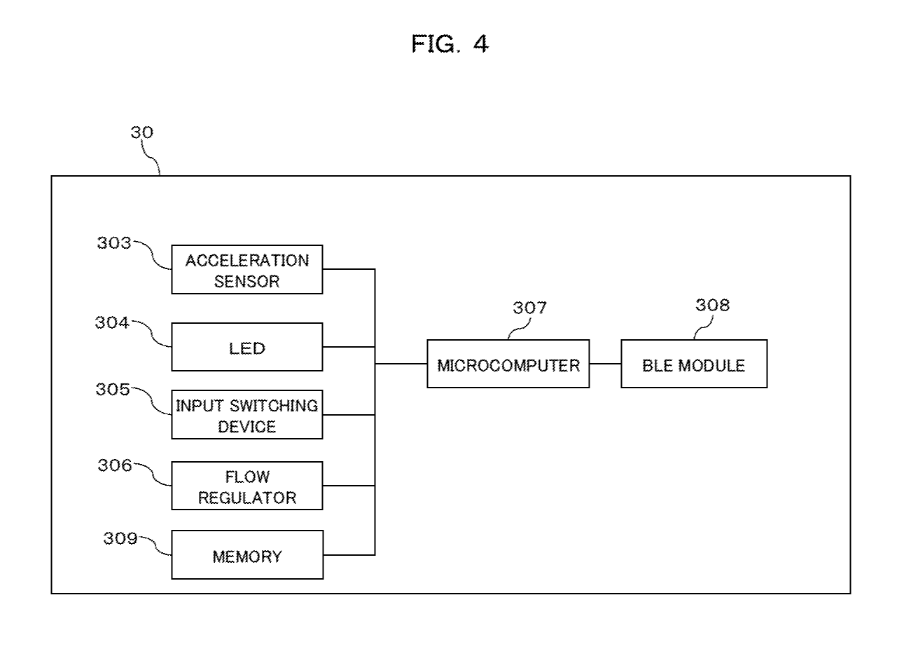

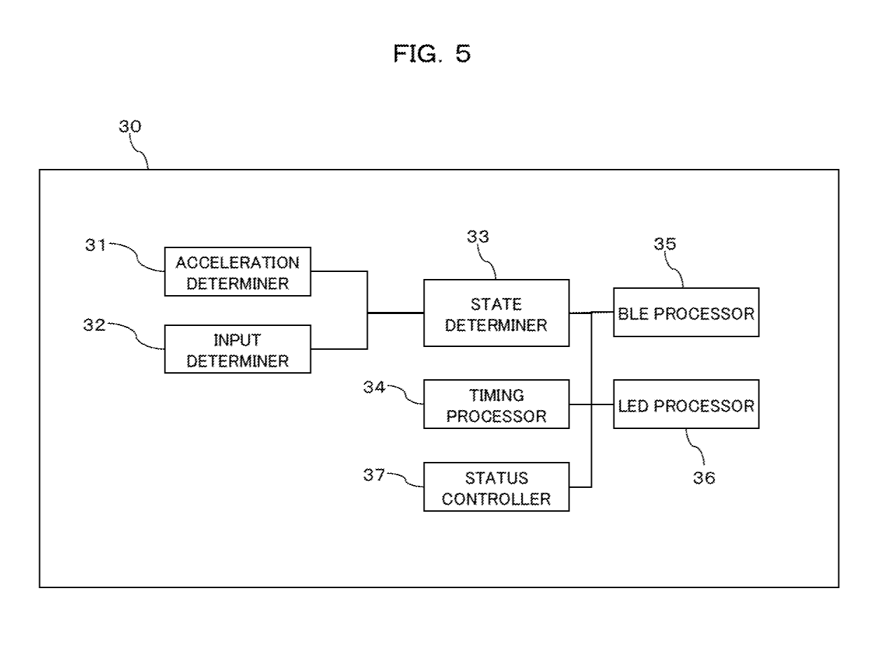

FIG. 2 is an external perspective view of a timing device 30 in the environment controlling system 1 according to the first embodiment; FIG. 3 is a side view of the timing device 30; FIG. 4 is a block diagram illustrating the hardware configuration in the timing device 30; and FIG. 5 is a block diagram illustrating a functional configuration of the timing device 30.

The timing device 30 is used to measure the time length of the use of the room 2 by the user. The timing device 30 is also used to set a desirable environment (rendering) in the room 2 in accordance with the preference or purpose of the user of the room 2.

With reference to FIG. 3, the timing device 30 includes a first vessel 301a, a second vessel 301b, and a cover 302. For example, the first vessel 301a and the second vessel 301b are substantially conical having hollow interiors. The first vessel 301a and the second vessel 301b are in connection with each other at their narrow necks to communicate with each other. In other words, the first vessel 301a and the second vessel 301b constitute a necked central joint.

At least the first vessel 301a is composed of a transparent material, such as glass and transparent resin, such that the flow of the sand into the vessel can be visually observed through the vessel. The first vessel 301a and the second vessel 301b contain sand 310, which is a mere example of particulate solid contained in these vessels, and thereby constitute an hourglass.

Hereinafter, the timing device 30 is in a normal state while the first vessel 301a is being positioned upward, whereas the timing device 30 is in an inverted state while the second vessel 301b is being positioned upward.

At the start of the use of the room 2, the user inverts the timing device 30 upside down from the normal state to the inverted state to start the flow of the sand 310 into the first vessel 301a. In other words, the inversion of the timing device 30 from the normal state to the inverted state corresponds to the start of the chronometry with the timing device 30. That is, the timing device 30 is in an operational mode while the timing device 30 is being in the inverted state.

The second vessel 301b may be composed of transparent material, for example, glass or transparent resin, like the first vessel 301a, such that the amount of the sand (or any other particulate solid) in the second vessel 301b can be visually observed. Alternatively, the second vessel 301b may be composed of translucent material, for example, frosted glass or translucent resin, through which light can transmit but the interior of the second vessel 301b is invisible. In the operation mode or the inverted state of the timing device 30 in which the second vessel 301b is positioned upward, the second vessel 301b may be illuminated by a light source disposed therein for visual confirmation of the operational mode of the timing device 30.

The user reinverts the timing device 30 from the inverted state to the normal state to stop the flow of the sand 310 into the first vessel 301a. In other words, the reversion of the timing device 30 from the inverted state to the normal state corresponds to the stop of the chronometry with the timing device 30. That is, the timing device 30 is in a non-operational mode while the timing device 30 is being in the normal state.

In the environment controlling system 1, the user inverts the timing device 30 to the inverted state to start the use of the room 2, and reinverts the timing device 30 to the normal state to end the use of the room 2.

In other words, the inversion of the timing device 30 to the inverted state by the user indicates the start of the use of the room 2, and the reversion of the timing device 30 to the normal state by the user indicates the end of the use of the room 2.

In such a timing device 30, the amount of the sand 310 flowing from the second vessel 301b and accumulated in the first vessel 301a indicates the elapsed time from the inversion of the timing device 30 to the inverted state. The timing device 30 thereby indicates the elapsed time from the time point at the inversion.

The user in the room 2 can confirm the elapsed time from the start of the chronometry with the timing device 30 by visual observation of the amount of the sand 310 accumulated in the first vessel 301a.

For the timing device 30, the diameter of the communication port or neck between the first vessel 301a and the second vessel 301b and the amount of the sand 310 are appropriately determined so that entire sand 310 in the second vessel 301b does not flow into the first vessel 301a before the end of a general time length of use of the room 2 (for example, about one to two hours).

In the environment controlling system 1, the sand 310 is contained in the first vessel 301a and the second vessel 301b; instead, any other material, such as fluid, may be contained in the vessels. In specific, any other particulate solid other than sand may be contained. In place of particulate solid, liquid may be contained in the vessels. Any other modification can be applied to the embodiment.

At the communication port between the first vessel 301a and the second vessel 301b, a flow regulator 306 is disposed to regulate the flow of the sand 310 at a predetermined rate. The flow regulator 306 includes a regulating mechanism, such as a valve and a shutter, (not shown) that can vary the diameter of the communication port between the first vessel 301a and the second vessel 301b to a predetermined diameter.

Closing the communication port between the first vessel 301a and the second vessel 301b with the flow regulator 306 hinders the transfer of the sand 310 between the first vessel 301a and the second vessel 301b and the flow of the sand 310 is thereby stopped. As the diameter of the communication port between the first vessel 301a and the second vessel 301b regulated with the flow regulator 306 increases, the flow rate of the sand 310 between the first vessel 301a and the second vessel 301b increases. Such a configuration can reduce the transfer time of the sand 310 from one vessel (for example, the second vessel 301b) to the other vessel (for example, the first vessel 301a). In an embodiment, the diameter of the communication port is regulated with the flow regulator 306 in accordance with a predetermined measuring time so that the entire sand does not flow from the second vessel 301b into the first vessel 301a at the end of the predetermined measuring time. In another embodiment, the flow regulator 306 regulates the communication port to have a maximum diameter upon the reversion of the timing device 30 from the inverted state to the normal state (i.e., upon the change in state of the timing device 30 from the operational state to the non-operational state) so that the sand accumulated in the first vessel 301a rapidly returns into the second vessel 301b.

In the inverted state of the timing device 30, at least one light emitting diode (LED) (not shown) disposed on the second vessel 301b or the cover 302 emits light. The user can thereby readily confirm the state of the timing device 30, i.e., the inverted or normal state.

The cover 302 is provided with an operation switch (not shown) to cause the flow regulator 306 to regulate the communication port to have a predetermined diameter. The operator can control the transfer of the sand 310 between the first vessel 301a and the second vessel 301b at any rate through the operation with the operation switch.

The regulation of the diameter of the communication port with the flow regulator 306 may be controlled by a microcomputer 307.

The cover 302 surrounds the communication port between the first vessel 301a and the second vessel 301b. With reference to FIG. 4, the cover 302 is provided with an acceleration sensor 303, at least one LED 304, an input switching device 305, a microcomputer 307, a Bluetooth (registered trademark) low energy (BLE) module 308, and a memory 309, for example.

For example, the acceleration sensor 303 is a triaxial acceleration sensor that can detect the gravity and tilt. Such an acceleration sensor 303 can detect the direction of the gravity and a change in posture of the timing device 30, for example.

For instance, at a 180-degree rotation (inversion or reversion) of the timing device 30 by the operator, the acceleration sensor 303 detects the inversion or reversion of the timing device 30 (detection of inversion or reversion, or detection of rotation). The acceleration sensor 303 can also detect an external impact on the timing device 30. The results detected at the acceleration sensor 303 are input in the microcomputer 307.

The operator performs the input operation with the input switching device. For example, the input switching device 305 is a button switch. The operator inputs (sets) a predetermined rendering mode with the input switching device 305, for example.

The rendering mode indicates the type of the rendering performed in the environment of the room 2. In the environment controlling system 1, several rendering modes (four modes in this embodiment) are prepared, and the operator selects a desired mode from the rendering modes with the input switching device 305.

In the embodiment, the following rendering modes are prepared.

Rendering mode 1: Forest

Rendering mode 2: Ocean

Rendering mode 3: Cafe

Rendering mode 4: Library

In the room 2, the rendering in accordance with these rendering modes are achieved with the lighting device 21, the projector 22, and the audio device 23.

In specific, Rendering mode 1 (Forest) is achieved with the projector 22 that projects static or moving images of the landscape in a forest on the screen 22a and the audio device 23 that produces sound effects, such as birdsong and murmur of the wind in the trees, for example.

Rendering mode 2 (Ocean) is achieved with the projector 22 that projects static or moving images of the landscape of a seaside on the screen 22a and the audio device 23 that produces sound effects, such as roar of waves, for example. In addition, the interior of the room 2 is brightly illuminated with the lighting device 21.

Rendering mode 3 (Cafe) is achieved with the projector 22 that projects static or moving images of the landscape in a cafe on the screen 22a and the audio device 23 that produces back-ground music, for example, jazz or classical music. In addition, the interior of the room 2 is dimly illuminated with warm-color light from the lighting device 21 to create a relaxed atmosphere in the room 2.

Rendering mode 4 (Library) is achieved with the projector 22 that projects static or moving images of the landscape in a library on the screen 22a, for example. In this rendering mode, the audio device 23 produces no music or no sound effects. The interior of the room 2 is dimly illuminated with the lighting device 21 to create a relaxed atmosphere in the room 2.

The operator inputs a predetermined measuring time with the input switching device 305. The predetermined measuring time refers to the time period while the rendering modes described above are performed, i.e., the time length of use of the room by the operator (for example, 30 minutes, 60 minutes, 90 minutes, or 120 minutes). The management server 10, which is described below, performs the chronometry until the end of the predetermined measuring time. That is, the predetermined measuring time input, with the input switching device 305 corresponds to a time length to be measured from a time point at the inversion of the timing device 30.

In addition, the operator can reset the input with the input switching device 305.

The rendering mode and the measuring time input with the input switching device 305 are stored in a predetermined area in a memory (not shown) (status controller 37; see FIG. 5).

The specifications, such as shape and input scheme of the input switching device 305 may be appropriately modified. The detailed description on the modification is omitted. In an embodiment, the input switching device 305 includes several input switches having different functions, and the input of a selected function is determined based on the input switch operated. In another embodiment, the input switching device 305 includes a single input switch having various functions to be activated by different input operations, and the input of a selected function is determined based on the input operation with the input switch (for example, holding down the button for a predetermined period, or holding down the button predetermined times). In still another embodiment, the cover 302 is rotatable relative to the first vessel 301a and the second vessel 301a, and different functions are assigned to discrete rotational angles. In this embodiment, different input signals are generated at the respective rotation angles defined by the rotation of the cover 302 or the rotation of the first vessel 301a and the second vessel 301b relative to the cover 302 by the user.

The input switching device 305 includes an input switch to operate the flow regulator 306 described above.

The cover 302 is provided with one or more LEDs 304. The LEDs 304 emit light under the control of the microcomputer 307. In the environment controlling system 1, various informative functions are achieved by flashing the LEDs 304 in predetermined colors, blinking the LEDs 304 in predetermined patterns, or flashing some of the LEDs 304, for example.

In an embodiment, the cover 302 is provided with several LEDs 304 emitting different colors (for example, red, yellow, blue, and green). The microcomputer 307, which is described below, causes any one of the LEDs 304 to emit in accordance with the rendering mode input with the input switching device 305 described above, and the selected rendering mode is thereby indicated.

In another embodiment, the cover 302 is provided with several LEDs 304 disposed side by side. Any one of the LEDs 304 corresponding to the predetermined measuring time input by the operator using the input switching device 305 emits light to indicate the predetermined measuring time.

The BLE module 308 conducts wireless communication with the management server 10 and BLE communication with the BLE module 19 of the management server 10 described below.

The memory 309 stores data and programs. For example, the memory 309 stores identification information (identifier) of the timing device 30 and the rendering mode and the predetermined measuring time that are input with the input switching device 305, in a predetermined area in the memory 309.

The microcomputer 307 controls the functions of the timing device 30, i.e., the functions of an acceleration determiner 31, an input determiner 32, a state determiner 33, a timing processor 34, a BLE processor 35, and LED processor 36, and a status controller 37 illustrated in FIG. 5.

The microcomputer 307 is a processor embedded in an integrated circuit and includes a central processing unit (CPU) core (not shown), for example.

The CPU core runs the program stored in the memory 309 to operate the acceleration determiner 31, the input determiner 32, the state determiner 33, the timing processor 34, the BLE processor 35, the LED processor 36, and the status controller 37 illustrated in FIG. 5.

The program including processes to be executed by the CPU core of the microcomputer 307 may be stored in a nonvolatile portable recording medium, such as a memory card. The program stored in the portable recording medium is loaded to be executed in the memory 309 under the control of the CPU core. Alternatively the CPU core may directly execute the program stored in the portable recording medium.

The acceleration determiner 31 determines the posture and change in state of the timing device 30 based on the results detected at the acceleration sensor 303.

For example, the acceleration sensor 303 determines the 180-degree rotation (inversion or reversion) of the timing device 30 (detection of inversion or reversion). In other words, the acceleration sensor 303 is a detector to detect the inversion and reversion of the timing device 30.

The acceleration determiner 31 determines whether the first vessel 301a of the timing device 30 is positioned upward or not (detection of posture, determination of inversion or reversion).

In the environment controlling system 1, the inversion of the timing device 30 from the normal state to the inverted state corresponds to an input operation to start the chronometry. The input operation causes the flow of the sand 310 from the second vessel 301b into the first vessel 301a.

In contrast, a 180-degree rotation or reversion of the timing device 30 from the inverted state to the normal state corresponds to another input operation to stop the chronometry. The input operation causes the flow of the sand 310 from the first vessel 301a into the second vessel 301b.

The results detected at the acceleration determiner 31 are input in the state determiner 33.

The input determiner 32 determines an input operation with the input switching device 305. For example, the input determiner 32 determines a pressing operation of the input switching device 305 (determination of pressing) and a long pressing operation of the input switching device 305 (determination of long pressing).

The results determined by the input determiner 32 are input in the state determiner 33.

The state determiner 33 determines the occurrence of an event based on the results input from the acceleration determiner 31 and the input determiner 32.

For example, the state determiner 33 determines which event occurs in the timing device 30 based on the operation of the input switching device 305 determined with the input determiner 32 and the results detected at the acceleration determiner 31.

For example, the state determiner 33 determines the input of a predetermined rendering mode and the input of a predetermined measuring time from the input switching device 305.

The state determiner 33 determines the start of the chronometry in response to an input indicating the inversion (180-degree rotation) of the timing device 30 to the inverted state from the acceleration determiner 31.

The state determiner 33 determines the stop of the chronometry in response to an input indicating the reversion of the timing device 30 to the normal state from the acceleration determiner 31.

The state determiner 33 determines a reset operation with the input switching device 305.

The timing processor 34 executes chronometry. In an embodiment, the timing processor 34 measures an elapsed time from the start of the chronometry determined by the state determiner 33. When the elapsed time reaches the predetermined measuring time, the timing processor 34 causes the flow regulator 306 to close the communication port between the first vessel 301a and the second vessel 301b to stop the flow of the sand 310, for example.

The LED processor 36 controls the light emission of the LED(s) 304. For example, when the state determiner 33 determines an input operation to select a predetermined rendering mode with the input switching device 305, the LED processor 36 causes the light emission of at least one of the LEDs 304 appropriate to the selected rendering mode.

Furthermore, when the state determiner 33 determines an input operation to set a predetermined measuring time with the input switching device 305, the LED processor 36 causes the light emission of at least one of the LEDs 304 indicating the predetermined measuring time.

The status controller 37 controls the status of the timing device 30. For example, the status controller 37 searches the memory 309 for the rendering mode and the measuring time to confirm the status of the timing device 30.

The BLE processor (transmitter) 35 controls wireless communication with the management server 10. For example, the BLE processor 35 transmits the rendering mode and the measuring time input with the input switching device 305 to the management server 10.

When the state determiner 33 determines the inversion of the timing device 30 to the inverted state, the BLE processor 35 transmits the information on the rendering mode and the measuring time input in the timing device 30 and confirmed by the status controller 37 to the management server 10, together with the identifier of the timing device 30.

It should be noted that the information on the measuring time may be the measuring time itself, or may be any data corresponding to the measuring time. Any modification may be applicable to the information.

In specific, upon the detection of inversion of the timing device 30 to the inverted state by the acceleration sensor 303, the BLE processor 35 transmits a wireless signal to start the chronometry (alert signal, chronometry start alert, or first predetermined signal) including the identifier of the timing device 30 and the information on the selected rendering mode and the measuring time to the management server 10.

In addition, upon the detection of the reversion of the timing device 30 to the normal state, i.e. the stop of the chronometry, by the state determiner 33, the BLE processor 35 transmits a wireless signal to stop the chronometry (chronometry stop alert or second predetermined signal) indicating the stop of the chronometry to the management server 10.

In such a configuration, the BLE processor 35 transmits the signal to stop the chronometry (chronometry stop alert or second predetermined signal), which is different from the signal to start the chronometry, upon the detection of the reversion of the timing device 30 by the acceleration sensor 303.

### (1-1-3) Management Server

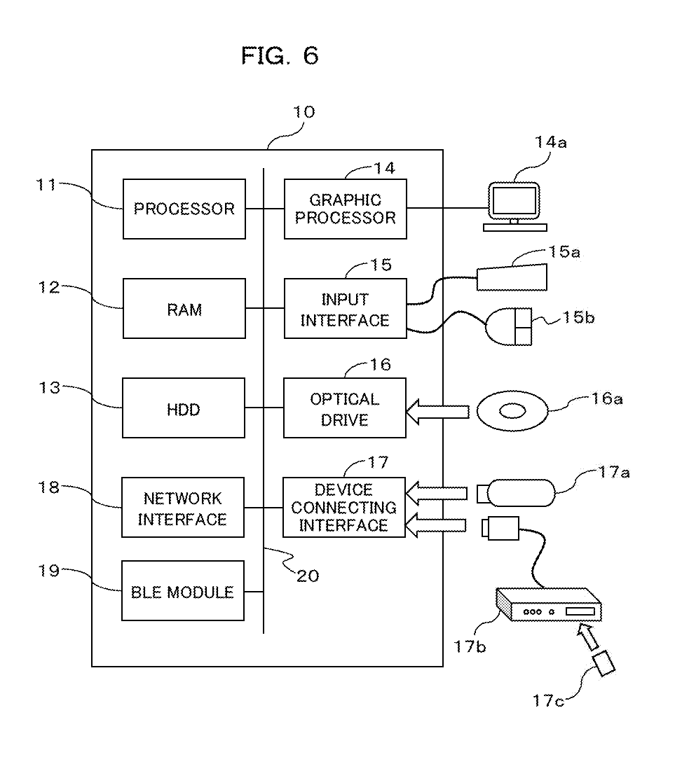

FIG. 6 illustrates the configuration of the hardware of the management server 10 in the environment controlling system 1 according to the first embodiment.

The configuration of the hardware of the management server 10 in the environment controlling system 1 according to the first embodiment will now be described with reference to FIG. 6.

The management server 10, which is a server computer (information processor), includes a processor 11, a random access memory (RAM) 12, a hard disk drive (HDD) 13, a graphic processor 14, an input interface 15, an optical drive 16, a device connecting interface 17, a network interface 18, and a BLE module 19. These components 11 to 18 can be communicated with one another via a bus 20.

The processor 11 controls the entire management server 10. The processor 11 may be a multiprocessor. The processor 11 may be, for example, any one of a central processing unit (CPU) a micro processing unit (MPU), a digital signal processor (DSP), an application specific integrated circuit (ASIC), a programmable logic device (PLD), and a field programmable gate array (FPGA). The processor 11 may be a combination of two or more components among CPU, MPU, DSP, ASIC, PLD, and FPGA.

The RAM 12 is used as a main memory of the management server 10. The RAM 12 temporarily stores at least some of operating system (OS) programs and application programs executed by the processor 11. The RAM 12 also stores various data required for processing by the processor 11. The application programs may include environment controlling programs executed by the processor 11 for achieving the environment control with the management server 10 according to the first embodiment.

The HDD 13 magnetically writes and reads data to and from the built-in disk. The HDD 13 is used as an auxiliary storage of the management server 10. The HDD 13 stores OS programs, application programs, and various data. The auxiliary storage may be a solid state drive (SSD), such as a flash memory.

The graphic processor 14 is connected to a monitor 14a. The graphic processor 14 displays an image on the screen of the monitor 14a in response to an instruction from the processor it. The monitor 14a may be, for example, a cathode ray tube (CRT) display or a liquid crystal display.

The input interface 15 is connected to a keyboard 15a and a mouse 15b. The input interface 15 transmits signals from the keyboard 15a and the mouse 15b to the processor 11. The mouse 15b, which is a pointing device, may be replaced with another pointing device. Examples of the pointing device other than the mouse include touch panels, tablets, touchpads, and trackballs.

The optical drive 16 reads data recorded on an optical disk 16a with, for example, a laser beam. The optical disk 16a is a portable nonvolatile recording medium storing data that can be read through the reflection of light. Examples of the optical disk 16a include digital versatile discs (DVDs), DVD-RAMs, compact disc read only memories (CD-ROMs), recordable compact discs (CD-Rs), and rewritable compact discs (CD-RWs).

The device connecting interface 17 is a communication interface for connecting the management server 10 to peripheral devices. For example, the device connecting interface 17 may be connected to a memory 17a or a memory reader/writer 17b. The memory 17a is a nonvolatile recording medium capable of communicating with the device connecting interface 17, such as a universal serial bus (USB) memory. The memory reader/writer 17b writes and reads data to and from a memory card 17c. The memory card 17c is a nonvolatile recording medium.

The network interface 18 is connected to a network (not shown). The network interface 18 sends and receives data to and from another computer or communication device via the network.

The BLE module 19 establishes wireless communication with the timing device 30. Specifically, BLE communication is established between the BLE module 19 and the BLE module 308 of the timing device 30.

The management server 10 executes programs (e.g., environment controlling programs) stored in, for example, a nonvolatile computer-readable recording medium, to achieve the environment controlling function according to the first embodiment. The programs executed by the management server 10 may be stored in various recording media. For example, the programs executed by the management server 10 may be stored in the HDD 13. The processor 11 loads at least some of the programs in the HDD 13 onto the RAM 12 and executes the loaded programs.

The programs to be executed by the management server 10 (processor 11) may be stored in a portable nonvolatile recording medium, such as the optical disk 16a, the memory 17a, or the memory card 17c. The programs stored in such a portable recording medium can be installed in the HDD 13 and then executed under the control by the processor 11. The processor 11 can read the programs directly from the portable recording medium and then execute the programs.

The configuration of the management server (information processor or computer) 10, which has the environment controlling function according to the first embodiment, will now be described with reference to FIG. 1.

The management server 10 functions to control the environment of each room 2. As illustrated in FIG. 1, the management server 10 includes the receiver 101, the timer 102, the rendering administrator 103, the rendering controller 109, the device controller 110, and the rendering data storage 108.

The processor illustrated in FIG. 6 executes the aforementioned environment controlling programs and thus controls the functions of the timer 102, the rendering administrator 103, the rendering controller 109, the device controller 110, and a relay 107.

The relay 107 relays various data between the receiver 101, the timer 102, the rendering administrator 103, and the rendering controller 109. For example, the bus 20 illustrated in FIG. 6 functions as the relay 107.

The receiver 101 receives a signal indicating the start of the chronometry (chronometry start signal) transmitted from the timing device 30. The signal includes the identification information of the timing device 30, the rendering mode, and the predetermined measuring time. The receiver 101 also receives a signal indicating the stop of the chronometry (chronometry stop signal) transmitted from the timing device 30.

The timer 102 measures an elapsed time after the reception of the chronometry start signal by the receiver 101. The timer 102 starts the chronometry when the receiver 101 receives the chronometry start signal from the timing device 30. The timer 102 informs the rendering controller 109 of the elapse of the predetermined measuring time.

The environment controlling system 1 includes a plurality of timing devices 30, and the timer 102 performs the chronometry for each of the timing devices 30.

The device controller 110 controls target devices in correspondence with each timing device 30. Specifically, the device controller 110 controls one or more target devices in the room 2 (the lighting device 21, the projector 22, the audio device 23, and the air conditioner 23) having the device identification information in correspondence with the identification information of the timing device 30 in the room 2.

Thus, the lighting device 21, the projector 22, the audio device 23, and the air conditioner 24, which are to be controlled by the rendering controller 109, can be identified on the basis of the identification information of the timing device 30 received by the receiver 101.

The rendering data storage 108 stores one or more types of rendering data (control scenarios). The rendering data are used for setting of the environment in the room 2, and the devices accommodated in the room 2 are controlled on the basis of the rendering data.

The stored rendering data correspond to the aforementioned rendering modes. As described above, the environment controlling system 1 provides four rendering modes 1 to 4, and the rendering data storage 108 stores at least four types of rendering data corresponding to these four rendering modes 1 to 4.

Each type of rendering data includes information on lighting control, projector control, sound control, and control of air conditioning.

The lighting controlling information is used for achieving a desired brightness or color of lighting in the room 2 with the dimming and toning functions of the lighting device 21. For example, the lighting controlling information includes information for controlling the brightness and color of light from the lighting device 21.

The information on projector control is used for allowing the projector 22 to project a predetermined image on the screen 22a in the room 2. The projector controlling information includes the file name of image data to be projected by the projector 22 and the storage position of the data. The projector controlling information may include image data to be projected.

The information on sound control is used for allowing the audio device 23 in the room 2 to produce predetermined musical sounds or sound effects. The sound controlling information includes the file name of data on musical sounds or sound effects (sound data) to be produced by the audio device 23 and the storage position of the data. The sound controlling information may include sound data to be produced. The sound controlling information may include the aforementioned image data together with the sound data.

The information on control of air conditioning includes the temperature, humidity, and air flow to be controlled by the air-conditioner controller 106. The information on control of air conditioning by the air-conditioner controller 106 may be appropriately modified. For example, the air-conditioner controller 106 may only control the turning on/off of the air conditioner 24, and the predetermined temperature, humidity, and air flow may be controlled by the air conditioner 24.

The rendering data corresponding to each of the aforementioned rendering modes is stored in the rendering data storage 108, and the information identifying the rendering mode is appropriately correlated with the information on lighting control, projector control, sound control, and control of air conditioning.

The rendering data includes several rendering sub data for predetermined measuring times. Specifically, each rendering sub data corresponds to a predetermined measuring time (e.g., 30 minutes, 60 minutes, 90 minutes, or 120 minutes).

In the case of the rendering data for rendering mode 3 (Cafe) (predetermined measuring time: 60 minutes), for example, the audio device 23 is controlled to play quiet music and sound effects for the initial 30 minutes and fast-tempo music for the subsequent 30 minutes.

In the case of the rendering data for rendering mode 3 (Cafe) (predetermined measuring time: 90 minutes), for example, the audio device 23 is controlled to play quiet music and sound effects for the initial 60 minutes and fast-tempo music for the subsequent 30 minutes.

The lighting device 21 is controlled in synchronization with switching of the music played by the audio device 23 so that the relaxed atmosphere in the room 2 dimly illuminated with warm-color light is changed into a bright atmosphere.

A meeting in the room 2 under such a rendering mode can proceed in a relaxed and quiet atmosphere at the initial stage and can ignite a heated discussion 30 minutes before the end of the meeting. Thus, the rendering mode enables an effective use of the room 2 within a predetermined available time.

The end of the predetermined measuring time may be announced to the user five minutes before the stop of the chronometry by playing of music or sound effects indicating the end of the use (e.g., preannouncing music or chime) together with bright illumination of the room 2.

To change music or sound effects output from the audio device 23 at a predetermined timing in the predetermined measuring time, the rendering controller 109 (content player 105) transmits sound controlling information for changing the music at a predetermined timing (e.g., after the elapse of 30 minutes and 55 minutes) on the basis of the rendering data.

To change the brightness and color of light from the lighting device 21 at a predetermined timing (e.g., after the elapse of 30 minutes and 55 minutes) in the predetermined measuring time, the rendering controller 109 (lighting controller 104) transmits lighting controlling information for changing the brightness and color of light at a predetermined timing (i.e., after the elapse of 30 minutes and 55 minutes) on the basis of the rendering data. Thus, the rendering controller 109 controls the type of the control signal to be transmitted to a predetermined device and the timings of transmissions of the signal within the predetermined measuring time on the basis of the rendering data.

Although the rendering data are used for changing the music played by the audio device 23 in response to the elapsed time as described above, the rendering data may be used for various other applications.

For example, the rendering data may be used for changing an image to be projected by the projector 22 in response to the elapsed time, or may be used for varying the temperature in the room 2 with the air conditioner 24 in response to the elapsed time.

The control of target devices using the rendering data in response to the elapsed time may be performed in various patterns.

The rendering administrator 103 retrieves, from the rendering data storage 108, the rendering data corresponding to the rendering mode and the predetermined measuring time included in the information received by the receiver 101 from the timing device 30.

The rendering administrator 103 transmits the retrieved rendering data to the rendering controller 109 via the relay 107.

The rendering controller 109 controls the devices accommodated in the room 2 using the rendering data, to provide the room 2 with an environment corresponding to the rendering mode.

The environment in the room 2 is determined and maintained on the basis of the rendering data during a period between the inversion of the timing device 30 to the inverted state and the end of the predetermined time input by the timing device 30, or the reversion of the timing device 30 to the normal state.

The rendering controller 109 functions as the air-conditioner controller 106, the lighting controller 104, and the content player 105, and controls the target devices accommodated in the room 2; i.e., the lighting device 21, the air conditioner 24, the projector 22, and the audio device 23.

The rendering controller 109 controls the target devices on the basis of the rendering data and the elapsed time measured by the timer 102.

The air-conditioner controller 106 controls the air conditioner 24 accommodated in the room 2. For example, the air-conditioner controller 101 starts air conditioning through activation of the air conditioner 24 in the room 2 accommodating the timing device 30 when the receiver 101 receives a chronometry start signal transmitted from the timing device 30. In this case, the air-conditioner controller 106 receives the rendering data from the rendering administrator 103, and transmits the information on control of air conditioning included in the rendering data to the air conditioner 24. The air conditioner 24 is operated on the basis of this information.

The air-conditioner controller 106 may transmit a control signal to the air conditioner 24 on the basis of the rendering data, to adjust the temperature and humidity in the room 2 in response to the elapsed time.

When the air-conditioner controller 106 receives a signal indicating the elapse of the predetermined time from the timer 102, the air-conditioner controller 106 transmits a signal instructing the stop of air conditioning to the air conditioner 24, to turn off the air conditioner 24.

The air-conditioner controller 106 also turns off the air conditioner 24 when the receiver 101 receives a chronometry stop signal from the timing device 30.

The lighting controller 104 controls the lighting device 21 accommodated in the room 2. For example, when the receiver 101 receives a chronometry start signal from the timing device 30, the lighting controller 104 turns on the lighting device 21 in the room 2 accommodating the timing device 30, to illuminate the room 2. In this case, the lighting controller 104 receives the rendering data from the rendering administrator 103, and transmits the lighting controlling information included in the rendering data to the lighting device 21. The brightness and color of light from the lighting device 21 are controlled on the basis of this information.

The lighting controller 104 transmits a control signal to the lighting device 21 on the basis of the rendering data, to adjust the brightness and color of the room 2 in response to the elapsed time.

When the lighting controller 104 receives a signal indicating the elapse of the predetermined time from the timer 102, the lighting controller 104 transmits a signal instructing the stop of illumination to the lighting device 21, to turn off the lighting device 21.

The lighting controller 104 also turns off the lighting device 21 when the receiver 101 receives a chronometry stop signal from the timing device 30.

The content player 105 controls the projector 22 and the audio device 23 accommodated in the room 2, to produce image data and sound data. For example, when the receiver 101 receives a chronometry start signal from the timing device 30, the content player 105 allows the projector 22 in the room 2 accommodating the timing device 30 to produce (project) image data specified by the projector controlling information.

The content player 105 allows the audio device 23 in the room 2 accommodating the timing device 30 to produce sound data specified by the sound controlling information.

The content player 105 may transmit image data or control signals to the projector 22 on the basis of the rendering data, to switch images to be projected in response to the elapsed time. The content player 105 may transmit sound data or control signals to the audio device 23 on the basis of the rendering data, to switch music to be played in the room 2 in response to the elapsed time.

When the content player 105 receives a signal indicating the elapse of the predetermined measuring time from the timer 102, the content player 105 transmits a signal instructing the stop of production of image data and sound data to the projector 22 and the audio device 23, to stop the production of the image data and the sound data.

The content player 105 also turns off the projector 22 and the audio device 23 when the content player 105 receives a chronometry stop signal (i.e., a signal indicating the reversion of the inverted timing device 30) from the timing device 30.

As described above, the rendering controller (transmitter) 109 starts to transmit the rendering data (control signal) corresponding to the rendering mode to the lighting device 21, the air conditioner 24, the projector 22, and the audio device 23 if the timing device 30 is determined to be in an operational mode from a chronometry start signal received by the receiver 101.

The rendering controller (transmitter) 109 transmits a signal instructing the stop of control to the lighting device 21, the air conditioner 24, the projector 22, and the audio device 23 in the room 2 if the timing device 30 is determined to be in a non-operational mode from a chronometry stop signal received by the receiver 101.

### (1-2) Operation

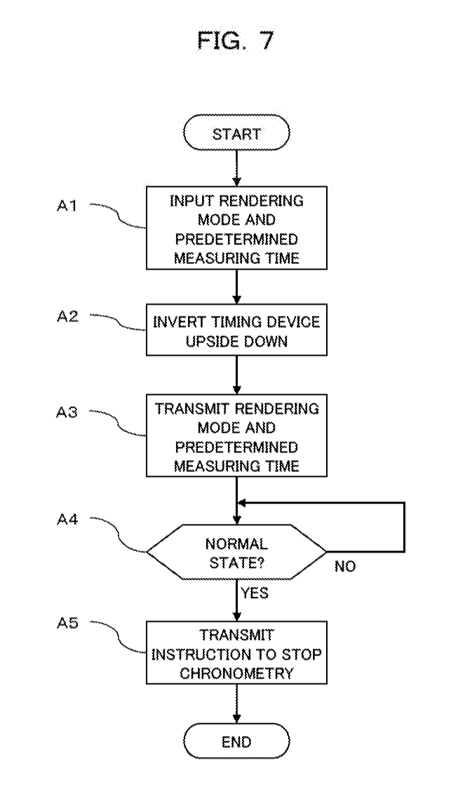

A process in the timing device 30 of the environment controlling system 1 according to the first embodiment will now be described with reference to a flow chart (Steps A1 to A5) of FIG. 7. The timing device 30 is placed in a normal state at the initial stage.

When the user of the room 2 operates the input switching device 305, the timing device 30 allows the user to input a rendering mode and a predetermined measuring time (Step A1). The predetermined measuring time is, for example, the utilization time of the room 2.

The LED processor 36 turns on the LED 304 according to the rendering mode inputted and the predetermined measuring time.

The tinting device 30 stores the inputted rendering mode and the predetermined measuring time in a predetermined area of the memory 309.

The acceleration sensor 303 detects the inverted state of the timing device 30 to which the rendering mode and the predetermined measuring time are input by the user. The inverted timing device 30 is placed, for example, on a table. In response to the signal from the acceleration sensor 303, the state determiner 33 confirms the inverted state of the timing device 30 and the start of the chronometry (Step A2).

The status controller 37 reads the rendering mode and the predetermined time from the memory 309, and the BLE processor 35 transmits chronometry start information including the rendering mode, the predetermined measuring time, and the identification information of the timing device 30 to a management server 10 (Step A3).

The state determiner 33 waits for a signal from the acceleration sensor 303 to confirm the return of the timing device 30 to the normal state (Step A4).

If the timing device 30 is not in the normal state (“NO” in Step A4), the process in Step A4 is repeated. If the state determiner 33 detects the normal state of the timing device 30 (“YES” in Step A4), the BLE processor 35 transmits a wireless chronometry stop signal that indicates the stop of the chronometry to the management server 10 (Step A5) to end the process.

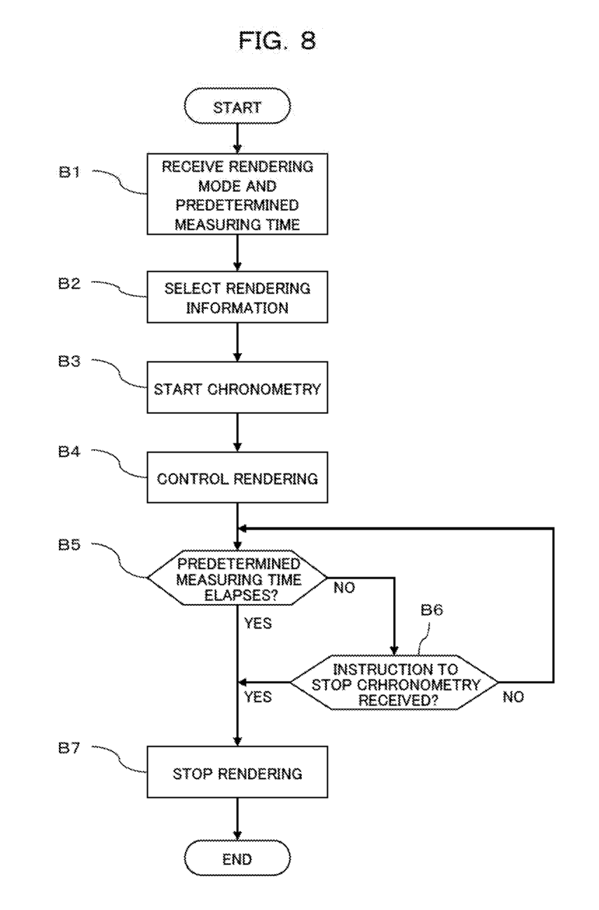

A process in the management server 10 of the environment controlling system 1 according to the first embodiment will now be described with reference to a flow chart (Steps B1 to B7) of FIG. 8.

The receiver 101 in the management server 10 receives the rendering mode, the predetermined measuring time, the identification information of the timing device 30 from the timing device 30 (Step B1).

The rendering administrator 103 selectively reads the rendering mode contained in the chronometry start signals and the rendering data corresponding to the predetermined measuring time from a plurality of pieces of rendering data from the rendering data storage 108 (Step B2). The timer 102 starts the chronometry (Step B3).

The device controller 110 identifies the lighting device 21, the air conditioner 24, the projector 22, and the audio device 23 corresponding to the timing device 30 that transmits the chronometry start signals to the receiver 101 and sends the results to the rendering controller 109.

The rendering controller 109 controls the lighting device 21, the projector 22, the audio device 23, and the air conditioner 24 in the room 2 with the rendering data read from the rendering data storage 108 (Step B4). The rendering controller 109 also controls the types and transmission timings of control signals often transmitted according to the rendering data for at least one predetermined device within the predetermined measuring time.

The air-conditioner controller 106 transmits the information on the control of air conditioning in the rendering data received from the rendering administrator 103 to the air conditioner 24 identified by the device controller 110 to control the air conditioner 24.

The lighting controller 104 controls the brightness and hue of light from the lighting device 21 identified by the device controller 110 with information on lighting control received from the rendering administrator 103.

The content player 105 allows the projector 22 identified by the device controller 110 to project images onto a screen using information on projector control in the rendering data received from the rendering administrator 103.

The content player 105 also allows the audio device 23 identified by the device controller 110 to produce sounds using information on sound control in the rendering data received from the rendering administrator 103.

The rendering controller 109 waits for a signal from the timer 102 to check for the elapse of the predetermined measuring time (Step B5). If the predetermined measuring time does not elapse, (“No” route in Step B5), the process goes to Step B6.

In Step B6, the rendering controller 109 confirms that the receiver 101 receives a signal indicating the stop of the chronometry from the timing device 30. If the receiver 101 has not received the signal indicating the stop of the chronometry (“NO” route in Step B6), the process returns to Step B5.

If the predetermined measuring time elapses (“YES” route in Step B5) and if the receiver 101 receives the signal indicating the stop of the chronometry from the timing device 30 (“YES” route in Step B6), the rendering controller 109 stops the control of the target device (Stop of rendering; Step B7) to complete the process.

### (1-3) Advantageous Effects

According to the environment controlling system 1 of the first embodiment, a user inputs a desired rendering mode and a predetermined measuring time and the inverted timing device 30 transmits a signal indicating the start of the chronometry to the management server 10.

The rendering controller 109 of the management server 10 activates the target devices in the room 2 in response to the rendering mode using the rendering data selected based on the signal indicating the start of the chronometry. This process can readily establish the environment of the room 2 with high convenience.

The rendering controller 109 switches the control of the devices in the room 2 depending on the elapsed time according to preliminarily prepared rendering data (operation controlling scenario) depending on the elapsed time. The user in the room 2 can enjoy the rendering using the target devices, and can effectively use the room 2.

After input of only the rendering mode and the predetermined measuring time by the user, the timing device 30 is turned upside down to the inverted state to transmit the information from the timing device 30 to the management server 10. Persons who cannot perform complicated operations, for example, children can readily operate the management server 10 to control the environment of the room 2. Such an operation can be achieved with high convenience independently of the type of the language.

The timing device 30 is an hour glass including a first vessel 301a and a second vessel 301b containing sand 310. The user can readily see the elapsed time after the inversion of the timing device 30.

Since the timing device 30 can transmit the identification information of the timing device 30 together with the signal indicating the start of the chronometry, the timing device 30 transmitting the signal indicating the start of the chronometry can be readily identified. The room 2 provided with the timing device 30 therein for control of the environment of the room 2 can be readily determined.

If two or more rooms 2 are under environmental control, the environment of the individual rooms 2 can be readily controlled.

### (2) Second Embodiment

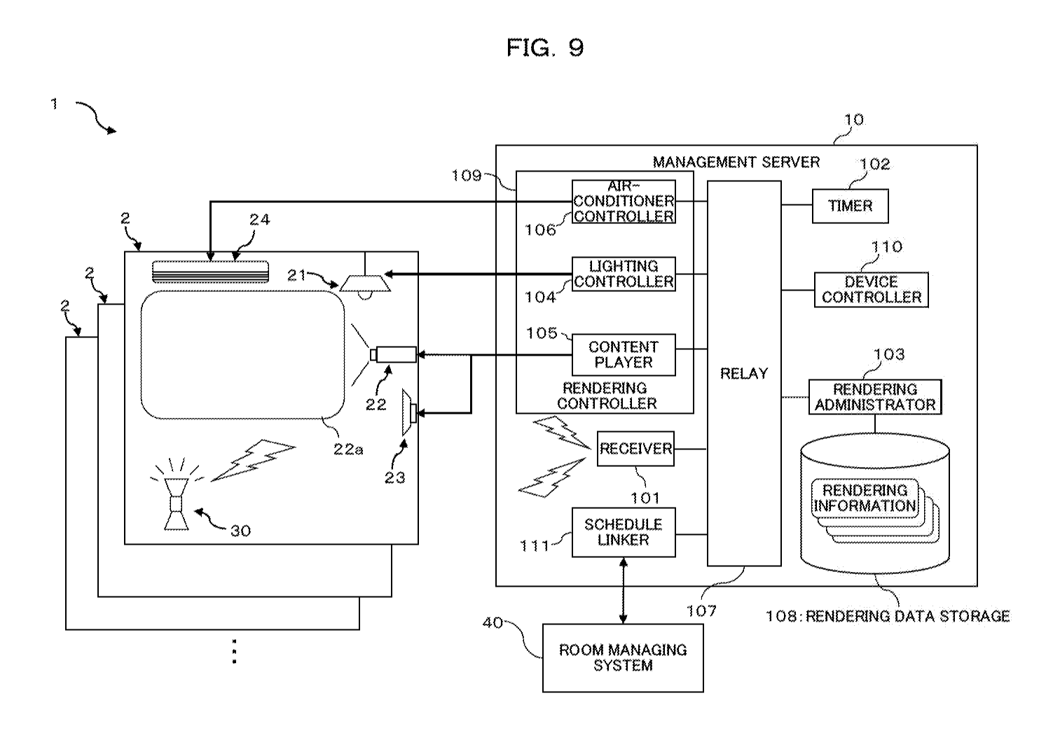

FIG. 9 is a schematic view of the environment controlling system 3 according to the second embodiment.

### (2-1) Configuration

As shown in FIG. 9, the environment controlling system 1 according to the second embodiment is connected to a room managing system 40 in a communicable manner and is provided with a schedule linker 111 in addition to the environment controlling system 1 of the first embodiment. The other portions have the same configuration as that of the environment controlling system 1 of the first embodiment. The same reference numerals in the drawings indicate the same components, and their redundant description is omitted.

The room managing system 40 manages the states of use of multiple rooms 2. The room managing system 40 manages the states of the use of individual rooms 2 and the prior booking of these rooms 2.

For example, the room managing system 40 controls the information on “in use” or “unused” of each room 2.

The room managing system 40 provides a user who wants to know the state of one of the rooms 2 with the information on “in use” or “unused”.

The user can know the state, “in use” or “unused”, of the desired room 2 through inquiry to the room managing system 40.

The room managing system 40 also manages prior booking of the individual rooms 2. The user can reserve a desired room 2 through input of the date and time of the use of the desired room 2.

For example, the user inputs the date and time of the use of the room 2 through the room managing system 40 for reservation of the room 2.

As described above, the room managing system 40 functions as a controller that controls the state of the use of a room (facility) 2 provided with target devices therein.

The user operates the room managing system 40 to change the state of the room 2 to “in use” before use of the room 2.

The user then operates the room managing system 40 to change the. state of the room 2 to “unused” before the end of the use of the room 2.

The schedule linker 111 links the environment controlling system 1 with the room managing system 40.

In detail, when the receiver 101 receives a signal notifying of the start of the chronometry from the timing device 30, the schedule linker 111 transmits an instruction to update the state of the room 2 provided with the timing device 30 therein to “in use” to the room managing system 40.

Upon the reception of the instruction, the room managing system 40 updates the state of the room 2 to “in use”.

Upon the reception of a signal to stop the chronometry from the inverted timing device 30, the schedule linker 111 transmits an instruction to update the state of the room 2 provided with the timing device 30 to “unused” to the room managing system 40.

Upon the reception of the instruction, the room managing system 40 updates the state of the room 2 to “unused”.

In the room managing system 40, the state of the room 2 can be changed to “in use” or “unused” from the exterior (the schedule linker 111 of the environment controlling system 1) in any known manner (detailed description thereof is omitted).

As shown in the first embodiment, inversion of the normal-state timing device 30 upside down in the environment controlling system 1 corresponds to the input operation indicating the start of the chronometry.

### (2-2) Operation

When the user of the room 2 operates the input switching device 305, the environment controlling system 1 according to the second embodiment allows the user to input a rendering mode and a predetermined measuring time of the timing device 30. The LED processor 36 tarns on the LED 304 according to the rendering mode inputted and the predetermined measuring time.

The state determiner 33 detects the inverted state of the timing device 30 to which the rendering mode and the predetermined measuring time are input by the user. The inverted timing device 30 is placed, for example, on a table. When the state determiner 33 detects the normal state of the timing device 30, the BLE processor 35 transmits a wireless signal indicating the stop of the chronometry to the management server 10.

The receiver 101 of the management server 10 receives the rendering mode, the predetermined measuring time, and the identification information of the timing device 30, which are transmitted from the timing device 30 as a signal to stop the chronometry. The rendering administrator 103 then selects and reads rendering data corresponding to the rendering mode received as the signal to start the chronometry from a plurality of pieces of rendering data stored in the rendering data storage 108.

The device controller 110 identifies the lighting device 21, the air conditioner 24, the projector 22, and the audio device 23 that correspond to the timing device 30 of the sender of the signal to start the chronometry received by the receiver 101 and transmits the signal to the rendering controller 109.

The rendering controller 109 controls the lighting device 21, the projector 22, the audio device 23, and the air conditioner 24 disposed in the room 2 using the rendering data read from the rendering data storage 108.

When the receiver 101 receives a signal to stop the chronometry from the timing device 30, the schedule linker 111 transmits an instruction to update the state of the room 2 provided with the timing device 30 to “in use” to the room managing system 40.

Upon the reception of the instruction to stop the chronometry, the room managing system 40 updates the state of the room 2 to “in use”.

When the receiver 101 receives a signal to stop the chronometry from the timing device 30, the rendering controller 109 stops the control of the target device. Upon reception of the signal to stop the chronometry from the inverted timing device 30, the schedule linker 111 transmits an instruction to update the state of the room 2 provided with the timing device 30 to “unused” to the room managing system 40.

Upon the reception of the update instruction, the room managing system 40 updates the state of the room 2 to “unused”.

### (2-3) Advantageous Effects

According to the environment controlling system 1 of the second embodiment described above, a signal indicating the start of the chronometry is transmitted from the timing device 30 inverted by the user in the room 2, and the schedule linker 111 transmits an instruction to update the state of the room 2 provided with the timing device 30 to “in use” to the room managing system 40.

The room managing system 40 receiving the instruction updates the state of the room 2 to “in use”.

Upon reception of a signal indicating the end of the chronometry from the timing device 30 reinverted to the original or normal state in the room 2, the schedule linker 111 transmits an instruction to update the state of the room 2 provided with the timing device 30 to “unused” to the room managing system 40.

The room managing system 40 receiving the instruction updates the state of the room 2 to “unused”.

In addition to the advantageous effects in the first embodiment, the environment controlling system 1 of the second embodiment also has the following advantageous effects:

Mere inversion of the timing device 30 upside down by the user of the room 2 can allow the schedule linker 111 to instruct the room managing system 40 to update the state of the room 2 provided with the timing device 30 to “in use”.

Mere reversion of the timing device 30 into the original or normal state by the user of the room 2 can allow the schedule linker 111 to instruct the room managing system 40 to update the state of the room 2 provided with the timing device 30 to “unused”.

These automatic operations can eliminate any input by the user to change the state of the room 2 to “in use” or “unused” through the room managing system 40.

This system can improve the user convenience. In addition, the state of the use of the room 2 managed by the room managing system 40 can be rapidly updated. The room managing system 40 rapidly establishes the “unused” state immediately after the vacancy of the room 2 to effectively promote the use of the vacant room 2.

This system also can prevent fictitious reservation of the room 2 by a user who does not actually use the room 2 regardless of reservation through the room managing system 40, resulting in effective promotion of the use of the room 2.

### (3) Miscellaneous

The embodiments described above should not be construed to limit the invention and can be modified in various manners within the scope of the present invention.

For example, the rendering controller 109 controls the target devices, such as the lighting device 21, the projector 22, the audio device 23, and the air conditioner 24 disposed in the room 2. The rendering controller 109 can also control any other electronic device, for example, an aroma diffuser in the room 2.

The timing device 30 may be provided with, for example, a liquid crystal touch panel that covers part or all of the functions of the input switching device 305 and the LED 304. The timing device 30 may have any configuration that can transmit the signals indicating the start and stop of the chronometry and preferably information on the rendering mode and the measuring time to the management server 10 other than the shape shown in FIG. 2 and other drawings. For example, the timing device 30 may be a doll. In this case, a signal indicating the start of the chronometry is transmitted upon detection of a predetermined operation of the doll, for example, shake-hands, pushing, stroking, and picking up and placing. The rendering mode and the predetermined measuring time may be input depending on the type of the operation of the doll.

The embodiments described above describe wireless connection between the timing device 30 and the management server 10 through BLE. Alternatively, any other communication scheme may be employed. The timing device 30 may be connected with the management server 10 through any other wireless communication scheme, for example, Bluetooth (registered trademark) or WIFI (Wireless Fidelity: registered trademark).

Persons skilled in the art can produce the device and system or perform the process disclosed in the embodiments.

According to an embodiment, devices constituting an environment can be controlled depending an elapsed time.

All examples and conditional language recited herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A control system comprising:
a timing device comprising:
detector to detect inversion of the timing device; and
a radiotransmitter to wirelessly transmit a predetermined signal including identification information of the timing device or information for determining a predetermined time from a time point at the inversion of the timing device, upon detection of the inversion by the detector, the timing device indicating an elapsed time from the time point at the inversion; and
a computer comprising:
a memory and a processor, wherein
the processor starts transmission of a control signal according to a control scenario determined with the predetermined signal to at least one predetermined device other than the timing device if switching of the timing device to an operational mode is determined with the predetermined signal received by a receiver, and transmits a signal indicating the end of the control for the at least one predetermined device if switching of the timing device to a nonoperational mode is determined with the predetermined signal received by the receiver.

2. The control system according to claim 1, wherein the at least one predetermined device comprises at least one of an air conditioner, an audio device, and a lighting device for a space in which the timing device is disposed.

3. The control system according to claim 1 wherein the at least one predetermined device comprises at least two of an air conditioner, an audio device, and a lighting device for a space in which the timing device is disposed.

4. The control system according to claim 1, wherein the timing device indicates the elapsed time with a particulate solid or a liquid.

5. The control system according to claim 1, wherein
the signal transmitted by the radiotransmitter is an identifier of the timing device, and
the transmitter of the computer starts the transmission of the control signal to the at least one predetermined device in connection with the identifier of the timing device received by the receiver.

6. The control system according to claim 1, wherein
the predetermined signal transmitted by the radiotransmitter includes information capable of determining the control scenario,
the processor starts the transmission of the control signal according to one control scenario selected from a plurality of control scenarios stored in the computer, the one control scenario being selected based on the predetermined signal received by the receiver.

7. The control system according to claim 1, wherein the processor manages a state of a facility as to whether the facility in which the at least one predetermined device is disposed is in use, and updates the state of the facility to a state indicating the use of the facility if the timing device is determined to be switched to an operational mode in response to the predetermined signal received by the receiver.

8. The control system according to claim 7, wherein the state of the facility is updated to an unused state if the switching of the timing device to the nonoperational mode is determined by the predetermined signal received by the receiver.

9. A timing device for indicating an elapsed time from a time point at inversion of the timing device, comprising:
a detector to detect the inversion of the timing device; and
a radiotransmitter to wirelessly transmit identification information of the timing device or a first signal for determining a predetermined time from a time point at the inversion of the timing device, upon detection of the inversion by the detector.

10. A timing device for indicating an elapsed time from a time point at inversion of the timing device, comprising:
a detector to detect inversion of the timing device; and
a radiotransmitter to wirelessly transmit a first signal for prompting a controller to start a control operation for at least one predetermined device, upon detection of the inversion by the detector.

11. The timing device according to claim 9, wherein the timing device indicates the elapsed time with a particulate solid or a liquid.

12. The timing device according to claim 10, wherein the timing device indicates the elapsed time with a particulate solid or a liquid.

13. The timing device according to claim 9, wherein the detector comprises an acceleration sensor to detect the direction of the gravity.

14. The timing device according to claim 9, wherein the radiotransmitter transmits the first signal or a second signal different from the first signal, upon detection of the reversion of the timing device by the detector.

15. A method executed by a computer, comprising:
receiving a signal transmitted from, a timing device in response to start of chronometry;
selecting an operation controlling scenario corresponding to a predetermined time on the basis of the received signal with reference to a storage that stores operation controlling scenarios in connection with predetermined times; and
controlling types and transmission timings of controlling signals that are transmitted multiple times within the predetermined time to at least one predetermined device according to the selected operation controlling scenario.

16. The method according to claim 15, wherein the computer further manage a state of a facility as to whether the facility in which the at least one predetermined device is disposed is in use, and updates the state of the facility to a state indicating the use of the facility in response to the reception of the signal.

17. The method according to claim 15, wherein the signal transmitted in response to the start of chronometry includes information specifying the predetermined time.
